(19) United States
(12) Patent Application Publication
(10) Pub. No.: US 2017/0134781 A1
(43) Pub. Date: May 11, 2017

(54) METHOD AND APPARATUS FOR REALIZING CUSTOM MENU, CLIENT AND SERVER

(71) Applicants: Le Holdings (Beijing) Co., Ltd., Beijing (CN); Le Shi Zhi Xin Electronic Technology (Tianjin) Lim, Beijing (CN)

(72) Inventors: Xiaoliang HU, Beijing (CN); Libiao WANG, Beijing (CN); Qinghua YE, Beijing (CN); Min LIU, Beijing (CN)

(21) Appl. No.: 15/244,158

(22) Filed: Aug. 23, 2016

Related U.S. Application Data
(63) Continuation of application No. PCT/CN2016/084669, filed on Jun. 3, 2016.

(30) Foreign Application Priority Data
Nov. 9, 2015 (CN) 2015107583640

(51) Int. Cl. H04N 21/2668; H04N 21/472; H04N 21/482; H04N 21/437; H04N 21/45; H04N 21/81

(52) U.S. Cl. CPC H04N 21/2668; H04N 21/4532; H04N 21/8173; H04N 21/4826; H04N 21/437; H04N 21/47205; G06F 3/04817

(57) ABSTRACT

Disclosed are a method and a device for realizing a custom menu based on a smart TV, including: receiving resource request information carrying a user ID sent by a client, wherein the resource request information is generated by the client according to a second trigger instruction of a user on an edit button in the custom menu; obtaining a channel list or an application list from a preset resource library according to the resource request information, and returning the channel list or the application list to the client; or sending the resource request information to a user center, thus allowing the user center to return a play record corresponding to the current user to the client according to the user ID.

### CROSS-REFERENCE TO RELATED APPLICATIONS

This application is a continuation of International Application No. PCT/CN2016084669, filed on Jun. 3, 2016, which is based upon and claims priority to Chinese Patent Application No. 2015107583640, filed on Nov. 9, 2015. The entire contents of both applications being incorporated herein by reference.

### BACKGROUND OF THE INVENTION

The disclosure relates to smart TV control technology, and in particular, to a method and a device for realizing a custom menu based on a smart TV, as well as a client and a server.

A smart TV is a smart multimedia terminal following the trend of “high definition”, “network” and “intelligence” of TV sets, and has the functions of obtaining program contents from the Internet, video systems, computers and other channels and clearly displaying the most needed contents of a consumer on a large screen by a simple and easy integrated operation interface. A user can watch movies, watch TV, play games and do other things through the smart TV, and can operate via a remote controller.

At present, when operating the smart TV by the remote controller, the user needs to log in and log out corresponding functions according to the layout of the TV UI, for example, if the user wants to watch a movie, he/she needs to enter a related video UI interface and click movie categories.

However, in the process of implementing the present disclosure, the inventor finds that the prior art at least has the following problems:

in the prior art, when the user operates on the smart TV, due to different habits of the user, the frequently used functions are also different, but the TV UI is not individually customized according to different user habits, therefore, the habitual operation of the user may be achieved by multiple clicks, in this way, the operation is very troublesome, and the experience is very poor.

### BRIEF SUMMARY OF THE INVENTION

The present disclosure provides a method and device for realizing a custom menu based on a smart TV, in order to solve the problem in the prior art that the TV UI cannot be customized according to different users' habits, resulting in troublesome user operations and failing to meet the viewing experience of the users.

According to one aspect of the present invention, a method for realizing a custom menu based on a smart TV is provided, including:

receiving resource request information carrying a user ID sent by a client, wherein the resource request information is generated by the client according to a second trigger instruction of a user on an edit button in the custom menu;

obtaining a channel list or an application list from a preset resource library according to the resource request information, and returning the channel list or the application list to the client; or

sending the resource request information to a user center, thus allowing the user center to return a play record corresponding to the current user to the client according to the user ID.

According to a second aspect of the present invention, an electronic device is provided, including: a memory and at least one central processing unit, where the memory is connected to the at least on central processing unit by using a bus, the memory is configured to store a computer instruction, and when the device runs, the at least on central processing units executes the device to execute the following operations: receiving resource request information carrying a user ID sent by a client, wherein the resource request information is generated by the client according to a second trigger instruction of a user on an edit button in the custom menu; obtaining a channel list or an application list from a preset resource library according to the resource request information, and returning the channel list or the application list to the client; or sending the resource request information to a user center, thus allowing the user center to return a play record corresponding to the current user to the client according to the user ID.

According to a third aspect of the present disclosure, non-transitory computer-readable storage medium storing executable instructions that, when executed by an electronic device with a touch-sensitive display, cause the electronic device to:

receiving resource request information carrying a user ID sent by the client, wherein the resource request information is generated by the client according to a second trigger instruction of a user on an edit button in the custom menu; obtaining a channel list or an application list from a preset resource library according to the resource request information, and returning the channel list or the application list to the client; or sending the resource request information to a user center, thus allowing the user center to return a play record corresponding to the current user to the client according to the user ID.

According to the method and the device for realizing the custom menu based on the smart TV, the client and the server, all channel lists and applications in the preset resource library, the play records of the user center and the shortcut icons of the application channels are issued to the client according to the user request, thus allowing the client to add and display the custom shortcut menu, providing convenience for the individual demand of the user, playing the advantages of the smart TV itself, improving the functional extensibility and convenience and greatly enhancing the user experience.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flowchart of a method for realizing a custom menu based on a smart TV provided by an embodiment of the present disclosure;

FIG. 2 is a flowchart of a method for realizing a custom menu based on a smart TV provided by another embodiment of the present disclosure;

FIG. 3 is a structural block diagram of a device for realizing a custom menu based on a smart TV provided by an embodiment of the present disclosure; and

FIG. 4 is a structural block diagram of a system for realizing a custom menu based on a smart TV provided by another embodiment of the present disclosure;

FIG. 5 is a schematic diagram of a solid structure of a client of the present disclosure;

FIG. 6 is a schematic diagram of a solid structure of a client of the present disclosure.

### DETAILED DESCRIPTION OF THE INVENTION

Embodiments of the present disclosure will be described in detail below, examples of the embodiments are shown in the accompanying drawings, throughout which identical or similar marks express identical or similar elements or elements with identical or similar functions. The embodiments described below with reference to the accompany drawings are exemplary, merely used for explaining the present disclosure, and cannot to be construed as limitations to the present disclosure.

Those skilled in the art can understand that, unless specifically stated, the singular forms “a”, “an”, “the” and “this” can also include plural forms. It should be further understood that the word “including” used in the description of the present disclosure means the presence of the features, integers, steps, operations, elements, and/or components, but does not exclude the presence or addition of one or more other features, integers, steps, operations, elements, components, and/or groups thereof.

Those skilled in the art can understand that, unless otherwise defined, all terms (including technical terms and scientific terms) used herein have the same meaning as the general understanding of those of ordinary skill in the art to which the present disclosure belongs. It should also be understood that, those terms defined in a universal dictionary, as an example, should be understood as having the same meanings as those in the context of the prior art, and unless otherwise specifically defined, will not be explained by ideal or too formal meanings.

FIG. 1 shows a flowchart of a method for realizing a custom menu based on a smart TV provided by an embodiment of the present disclosure.

Refer to FIG. 1, the method for realizing the custom menu based on the smart TV provided by the embodiment of the present disclosure specifically includes the following steps:

S11, a custom menu opening instruction is received, the custom menu is displayed in a current display interface, wherein the custom menu includes at least one shortcut icon; and

specifically, a shortcut key, namely a Le key, is provided on a remote controller of the smart TV, the user clicks the Le key to send the custom menu opening instruction to the smart TV, and after receiving the custom menu opening instruction, the shortcut icon of the custom menu is displayed in the current display interface of the TV UI. The user can independently and quickly manage the video channels, play records of the user and application contents to realize the custom menu function of the smart TV.

Wherein, the shortcut icon can be a shortcut icon of the video channels, the play records of the user, all channels and applications, the shortcut icon includes a character icon and a picture icon and the like, which is not specifically limited in the present disclosure.

S12, if receiving a first trigger instruction of a user on one shortcut icon in the custom menu, contents corresponding to the shortcut icon are displayed.

Specifically, when the smart TV receives the first trigger instruction of the user on one shortcut icon in the custom menu, the smart TV skips to the address corresponding to the triggered shortcut icon for the user and displays the contents corresponding to the shortcut icon. Convenience is provided for the individual demand of the user, the advantages of the smart TV itself are played, the functional extensibility and convenience are improved, and the user experience is greatly enhanced.

Wherein, the custom menu further includes: an edit button used for editing the corresponding shortcut icon; and

it should be noted that, in order to edit the custom menu according to the individual demand of the user, the custom menu of the embodiment is further provided with the edit buttons used for editing the shortcut icons of different categories. Wherein, the edit buttons can include an addition button for the shortcut icon of the video channels, an addition button for the shortcut icon of the application, an addition button for the play records and a deletion button for existing shortcut icons in the current custom menu. Specifically, applications or channels under signal source, video category, application, function and other labels can be added.

Wherein, the video category is all channel lists of LeTV version returned by a server, the channel lists are obtained by a timing script and are updated in a database, when setting a Le key channel, the client requests a server interface, and the server returns all channel information and channel icon addresses to the client; and

correspondingly, the method provided by the embodiment further includes: if receiving a second trigger instruction of the user on the edit button, generating resource request information according to the second trigger instruction, wherein the resource request information carries a user ID;

sending the resource request information to the server, thus allowing the server to obtain a resource list corresponding to the edit button according to the user ID and return the resource list to the client; wherein the step specifically includes:

sending the resource request information to the server, thus allowing the server to obtain a channel list or an application list from a preset resource library and return the channel list or the application list to the client; or, allowing the server to send the resource request information to a user center, thus allowing the user center to return a play record corresponding to the current user to the client according to the user ID.

The obtained resource list is displayed in the current display interface, and the custom menu of the current user is updated according to the addition operation triggered by the user on each resource shortcut icon in the resource list.

According to the method for realizing the custom menu based on the smart TV provided by the embodiment, the shortcut key, namely the Le key, is provided on the remote controller of the smart TV, after the Le key is clicked, the custom menu is displayed on the TV UI, the user can independently select the contents of the shortcut menu from shortcut icons of all video channels, play records of the user and all channels and applications provided by the server for the client, in order to define his exclusive shortcut menu. Convenience is provided for the individual demand of the user, the advantages of the smart TV itself are played, the functional extensibility and convenience are improved, and the user experience is greatly enhanced.

In addition, for the above method embodiment, for the purpose of simple description, the method embodiment is described as a series of action combinations, but those skilled in the art should be aware that the present disclosure is not limited to the described action sequence, secondly, those skilled in the art should also be aware that the embodiments described in the description are all preferred embodiments, and the involved actions are not absolutely necessary for the present disclosure.

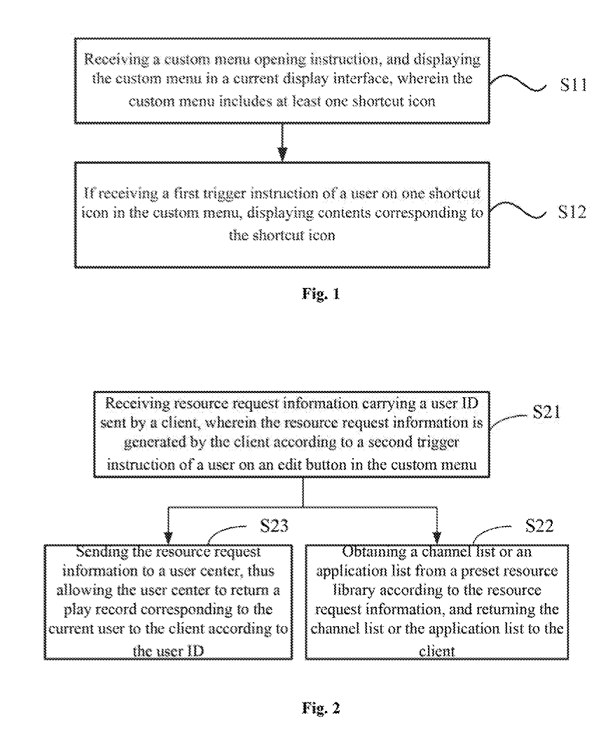

Based on the same inventive concept as the above method, another embodiment of the present disclosure further provides a method for realizing a custom menu based on a smart TV. FIG. 2 shows a flowchart of the method for realizing custom menu based on a smart TV provided by the embodiment of the present disclosure.

Refer to FIG. 2, the method for realizing the custom menu based on the smart TV provided by the embodiment of the present disclosure specifically includes the following steps:

S21, receiving resource request information carrying a user ID sent by a client, wherein the resource request information is generated by the client according to a second trigger instruction of a user on an edit button in the custom menu;

S22, obtaining a channel list or an application list from a preset resource library according to the resource request information, and returning the channel list or the application list to the client; or

S23, sending the resource request information to a user center, thus allowing the user center to return a play record corresponding to the current user to the client according to the user ID.

In the embodiment, after the server receives the resource request information carrying the user ID sent by the client, according to the resource type requested by the resource request information, if the resource request information is generated by the client according to a second trigger instruction of the user on a video channel edit button in the custom menu, the server determines that the resource requested by the resource request information is a video channel list, and enters the preset resource library, for example, a LeTV version interface or an application platform to obtain the channel list or the application list, and returns the channel list or the application list to the client; if the resource request information is generated by the client according to the second trigger instruction of the user on a play record edit button in the custom menu, the server determines that the resource requested by the resource request information is the play record of the current user, and sends the resource request information to the user center, thus allowing the user center to return the play record corresponding to the current user to the client according to the user ID.

In the embodiment of the present disclosure, the user can independently select the contents of the shortcut menu from shortcut icons of all video channels, play records of the user and all channels and applications provided by the server for the client, in order to define his exclusive shortcut menu. Convenience is provided for the individual demand of the user, the advantages of the smart TV itself are played, the functional extensibility and convenience are improved, and the user experience is greatly enhanced.

In the practical application of the embodiment of the present disclosure, the realized functional interfaces include:

Obtaining the Channel List Information:

A server background timing task obtains the channel list from the LeTV version interface every 1 minute and updates the channel list in the database. Further, if the data in the database are not in the obtained channel list, the server background timing task deletes the useless data in the database and updates the database to the latest channel; and when the client requests the channel list of the server, all channel information from the database list is obtained and returned.

2. Obtaining Application Icon Information:

An operation uploads the icon information of a corresponding application package name by a background, a background front end page uploads a picture to a cdn server through js and returns a request url to the rear end service and records the url information of the icon in the database, and when the client requests the application icon information, the server obtains all application package names, icon information and the like from the database and return the same.

3. Obtaining the Play Record of the User:

When the client requests the play record of the user from the server, the server obtains the request information sso_tk input by the client, generates a url request and sends the url request to the user center to obtain all play record of the users from the user center. And then, the server filters the play records according to a preset strategy and returns the filtered play records.

4. Deleting the Play Record of the User:

The user deletes one or all play records from the play records, when the client requests the server, vid, pid or flush and sso_tk need to be input, when flush is 0, it indicates that the play records are not cleared, at this time, the vid or pid information needs to be input, wherein vid expresses a video ID, pid expresses an album ID, and the server requests the user center to delete the play record of the users according to the url request generated by the vid, pid or flush and the sso_tk, and then returns an operation result to the client.

In the embodiment of the present disclosure, the method further includes:

after obtaining the channel list or the application list from the preset resource library, carrying out match setting on a channel shortcut icon of each channel in the channel list or on an application shortcut icon of each application in the application list according to a preset size of a shortcut icon in the custom menu of the client.

Specifically, the carrying out the match setting on the application shortcut icon of each application in the application list further includes the following steps:

checking whether a second application shortcut icon corresponding to the application ID of each application in the application list is stored in a first preset database; and using the found second application shortcut icon as the shortcut icon of the application corresponding to the application ID, wherein the size of the shortcut icon stored in the first preset database is matched with the preset size of the shortcut icon in the custom menu of the client.

Specifically, the carrying out the match setting on the channel shortcut icon of each channel in the channel list further includes the following steps:

checking whether a second channel shortcut icon corresponding to the channel ID of each channel in the channel list is stored in a second preset database; and using the found second channel shortcut icon as the shortcut icon of the channel corresponding to the channel ID, wherein the size of the shortcut icon stored in the second preset database is matched with the preset size of the shortcut icon in the custom menu of the client.

Further, the method further includes:

adding, modifying or deleting the shortcut icons stored in the first preset database and/or the second preset database.

In the embodiment, when a background management page modifies the channel icon, after receiving a request triggered after the operator clicks “modify the icon”, the front end schedules a picture uploading control to prompt the user to upload the picture and uploads the picture to the cdn server to obtain the url address of one picture, and then sends the channel id and the picture url to the server, the server obtains the channel id and the picture url and queries whether a corresponding channel exists in the database, and if so, updates the imgurl field of the corresponding channel in the database.

When an application icon is added in a background management page, an application name, an application package name, a corresponding picture address and other information filled by operation need to be received, wherein the step of obtaining the application icon url is the same as the above step, and then the application icon url is sent to the server to insert the data in the database; the operation of modifying the application ion is the same as the operation of modifying the channel icon; and when deleting the application ion, the application id is sent to the server, and the server deletes the record in the database through the id.

Further, before allowing the user center to return the play record corresponding to the current user to the client according to the user ID, the method further includes the following step not shown in the figure:

filtering the play record corresponding to the current user according to a preset strategy.

In the embodiment of the present disclosure, the data of the play record of the user returned by the server are from the user center, and the play record of the user is filtered via the strategy, and the specific filtering strategy is as follows:
a) filtering the play records uploaded by a non TV end in the State Administration of Radio version, and only retaining the records uploaded by the TV end; wherein the filtering is not carried out on other play control versions;
b) filtering non-feature film records of videos corresponding to the current play record in all versions, wherein the feature film herein is defined as follows: if the recorded videos belong to the channels of movies, TV series, cartoons, the videos must be feature films (feature films defined by media asset); and if the videos are self-made by the LeTV, the videos must be feature films (feature films defined by media asset) under constellations or zodiac signs;
c) if the video corresponding to the current play record has its album information, then: if the video belongs to CNTV play control, a media asset background needs to select a play control party to be online; and a play platform of the album must be provided with a TV end or a TV skip; and
d) if the video corresponding to the current play record does not have its album information, then: the play platform of the video must contain the TV end.

By adopting the method for realizing the custom menu based on the smart TV provided by the embodiment of the present disclosure, convenience is provided for the individual demand of the user, the advantages of the smart TV itself are played, the functional extensibility and convenience are improved, and the user experience is greatly enhanced.

Based on the same inventive concept as the method, another embodiment of the present disclosure further provides a device for realizing a custom menu based on a smart TV. FIG. 3 shows a structural block diagram of a device for realizing a custom menu based on a smart TV provided by the embodiment of the present disclosure.

Refer to FIG. 3, the device for realizing the custom menu based on the smart TV provided by the embodiment of the present disclosure specifically includes a receiving module 301 and a display module 302, wherein:

the receiving module 301 is used for receiving a custom menu opening instruction;

the display module 302 is used for displaying the custom menu in a current display interface when receiving the custom menu opening instruction, wherein the custom menu includes at least one shortcut icon;

the receiving module 301 is further used for receiving a first trigger instruction of a user on one shortcut icon in the custom menu; and

the display module 302 is further used for displaying contents corresponding to the shortcut icon, when receiving the first trigger instruction of the user on one shortcut icon in the custom menu.

In the embodiment, the custom menu further includes: an edit button used for editing the corresponding shortcut icon;

correspondingly, the receiving module 301 is further used for receiving a second trigger instruction of the user on the edit button;

the device further includes a generation module and a sending module, wherein:

the generation module is used for, if receiving the second trigger instruction of the user on the edit button, generating resource request information according to the second trigger instruction, wherein the resource request information carries a user ID;

the sending module is used for sending the resource request information to a server, thus allowing the server to obtain a resource list corresponding to the edit button according to the user ID and return the resource list to the client; and

further, the display module 302 is further used for displaying the obtained resource list in the current display interface and updating the custom menu of the current user according to an addition operation triggered by the user on each resource shortcut icon in the resource list.

In the embodiment, the sending module is specifically used for sending the resource request information to the server, thus allowing the server to obtain a channel list or an application list from a preset resource library and return the channel list or the application list to the client; or, allowing the server to send the resource request information to a user center, thus allowing the user center to return a play record corresponding to the current user to the client according to the user ID.

For the device embodiment, it is basically similar to the corresponding method embodiment, thus is described simply, and for related parts, please refer to a part of illustration to the method embodiment.

By adopting the device for realizing the custom menu based on the smart TV provided by the embodiment of the present disclosure, convenience is provided for the individual demand of the user, the advantages of the smart TV itself are played, the functional extensibility and convenience are improved, and the user experience is greatly enhanced.

In addition, according to another embodiment of the present disclosure, the present disclosure further provides a client, the client includes the device for realizing the custom menu based on the smart TV in the above embodiment, and the client provides convenience for the individual demand of the user, plays the advantages of the smart TV, improves the functional extensibility and convenience and greatly enhances the user experience.

Wherein, the client is a smart TV client.

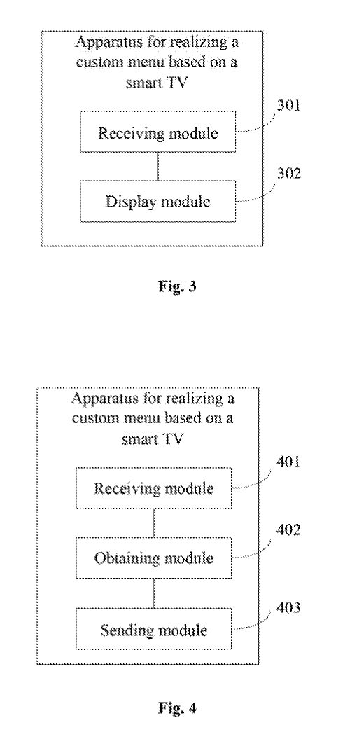

Based on the same inventive concept as the above method, another embodiment of the present disclosure further provides a device for realizing a custom menu based on a smart TV. FIG. 4 shows a structural block diagram of a device for realizing a custom menu based on a smart TV provided by the embodiment of the present disclosure.

Refer to FIG. 4, the device for realizing the custom menu based on the smart TV provided by the embodiment of the present disclosure specifically includes a receiving module 401, an obtaining module 402 and a sending module 403, wherein:

the receiving module 401 is used for receiving resource request information carrying a user ID sent by a client, wherein the resource request information is generated by the client according to a second trigger instruction of a user on an edit button in the custom menu;

the obtaining module 402 is used for obtaining a channel list or an application list from a preset resource library according to the resource request information, and returning the channel list or the application list to the client; and

the sending module 403 is used for sending the resource request information to a user center, thus allowing the user center to return a play record corresponding to the current user to the client according to the user ID.

The device provided by the embodiment further includes:

a match setting module used for, after obtaining the channel list or the application list from the preset resource library, carrying out match setting on a channel shortcut icon of each channel in the channel list or on an application shortcut icon of each application in the application list according to a preset size of a shortcut icon in the custom menu of the client.

Specifically, the match setting module is specifically used for checking whether a second application shortcut icon corresponding to the application ID of each application in the application list is stored in a first preset database, and using the found second application shortcut icon as the shortcut icon of the application corresponding to the application ID, wherein the size of the shortcut icon stored in the first preset database is matched with the preset size of the shortcut icon in the custom menu of the client.

Specifically, the match setting module is further specifically used for checking whether a second channel shortcut icon corresponding to the channel ID of each channel in the channel list is stored in a second preset database, and using the found second channel shortcut icon as the shortcut icon of the channel corresponding to the channel ID, wherein the size of the shortcut icon stored in the second preset database is matched with the preset size of the shortcut icon in the custom menu of the client.

The device provided by the embodiment further includes:

an editing module, used for adding, modifying or deleting the shortcut icons stored in the first preset database and/or the second preset database.

The device provided by the embodiment further includes:

a filtering module, used for filtering the play record corresponding to the current user according to a preset strategy, before allowing the user center to return the play record corresponding to the current user to the client according to the user ID.

By adopting the device for realizing the custom menu based on the smart TV provided by the embodiment of the present disclosure, convenience is provided for the individual demand of the user, the advantages of the smart TV itself are played, the functional extensibility and convenience are improved, and the user experience is greatly enhanced.

For the device embodiment, it is basically similar to the corresponding method embodiment, thus is described simply, and for related parts, please refer to a part of illustration to the method embodiment.

In addition, according to another embodiment of the present disclosure, the present disclosure further provides a server, including the device for realizing the custom menu based on the smart TV in the above embodiment, wherein the server provides convenience for the individual demand of the user, plays the advantages of the smart TV itself, improves the functional extensibility and convenience and greatly enhances the user experience.

In summary, according to the method and the device for realizing the custom menu based on the smart TV, the client and the server, all channel lists and applications in the preset resource library, the play records of the user center and the shortcut icons of the application channels are issued to the client according to the user request, thus allowing the client to add and display the custom shortcut menu, providing convenience for the individual demand of the user, playing the advantages of the smart TV itself, improving the functional extensibility and convenience and greatly enhancing the user experience.

FIG. 5 is a schematic diagram of a solid structure of a client of the present disclosure;

Refer to FIG. 5, the client provided by the embodiment of the present disclosure includes:

a processor 510, a communication interface 520, a memory 530 and a bus 540; wherein,

the processor 510, the communication interface 520 and the memory 530 communicate with each other by the bus 540;

the communication interface 520 is used for completing the information transmission of the client and a server;

the processor 510 is used for invoking a logic instruction in the memory 530 to execute the following method:

receiving a custom menu opening instruction, and displaying the custom menu in a current display interface, wherein the custom menu includes at least one shortcut icon; and if receiving a first trigger instruction of a user on one shortcut icon in the custom menu, displaying contents corresponding to the shortcut icon.

Refer to FIG. 1, the embodiment further provides a computer program, including a program code, wherein the program code is used for executing the following operations:

receiving a custom menu opening instruction, and displaying the custom menu in a current display interface, wherein the custom menu includes at least one shortcut icon;

and if receiving a first trigger instruction of a user on one shortcut icon in the custom menu, displaying contents corresponding to the shortcut icon.

The embodiment of the present disclosure further provides a storage medium, used for storing the above computer program.

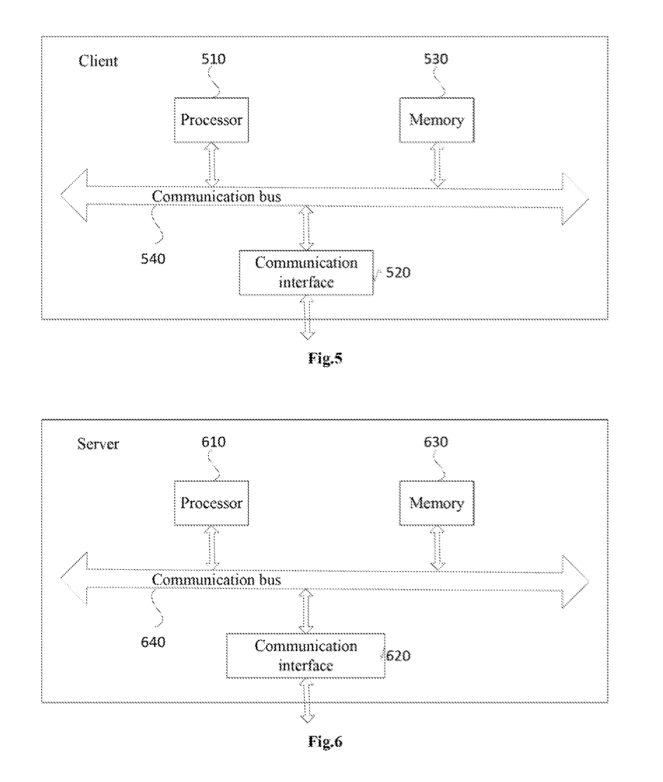

FIG. 6 is a schematic diagram of a solid structure of a server of the present disclosure.

Refer to FIG. 6, the server provided by the embodiment of the present disclosure includes:

a processor 610, a communication interface 620, a memory 630 and a bus 640; wherein,

the processor 610, the memory 630 and the communication interface 620 communicate with each other by the bus 640;

the communication interface 620 is used for completing the information transmission of the server and a client;

the processor 610 is used for invoking a logic instruction in the memory 630 to execute the following method:

receiving resource request information carrying a user ID sent by the client, wherein the resource request information is generated by the client according to a second trigger instruction of a user on an edit button in the custom menu; obtaining a channel list or an application list from a preset resource library according to the resource request information, and returning the channel list or the application list to the client; or sending the resource request information to a user center, thus allowing the user center to return a play record corresponding to the current user to the client according to the user ID.

Refer to FIG. 2, the embodiment further provides a computer program, including a program code, wherein the program code is used for executing the following operations:

receiving resource request information carrying a user ID sent by a client, wherein the resource request information is generated by the client according to a second trigger instruction of a user on an edit button in the custom menu;

obtaining a channel list or an application list from a preset resource library according to the resource request information, and returning the channel list or the application list to the client; or

sending the resource request information to a user center, thus allowing the user center to return a play record corresponding to the current user to the client according to the user ID.

FIGS. 5-6 are schematic diagrams of a hardware structure of an electronic device for executing a processing method of list item operations provided by the embodiments of the disclosure. The device includes: one or more processors and a memory, with one processor as an example in FIGS. 5-6.

The device for executing the processing method of list item operations may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:
1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.
2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.
3) Portable entertainment equipment: such equipment is able to display and play multimedia contents, and includes: audio and video players (e.g., iPod), handheld game players, electronic book readers, and smart toys and portable vehicle-mounted navigation equipment.
4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high. (5) Other electronic devices having the function of data interaction.

The embodiment of the present disclosure provides a non-volatile computer storage medium on which computer-executable instructions available for executing the processing method of list item operations in any method embodiment described above are stored, wherein the storage medium can be a magnetic disk, an optical disk, a read-only memory (ROM), a random access memory (RAM) or the like.

The device embodiments described above are merely schematic, in which units described as separate parts may be or may be not physically separated from one another, and parts displayed as units may be or may be not physical units, i.e., may be located at one place or distributed to a plurality of network units. Part or all of the modules therein may be selected according to actual requirements to achieve the objectives of the solutions in the present embodiment.

According to the above description of the embodiments, a person skilled in the art can clearly understand that various embodiments may be implemented by means of software in combination with a necessary general-purpose hardware platform, and of course, may also be implemented by means of hardware. Based on such understanding, the above technical solutions substantially or the parts making a contribution to the prior art may be embodied in the form of a software product, which can be stored in a computer-readable storage medium, such as an ROM/RAM, a magnetic disk, an optical disk or the like, and which includes a plurality of instructions for causing a computer device (which can be a personal computer, a server, a network device or the like) to execute various embodiments or the method described in some parts of the embodiments.

Finally, it should be noted that the above-mentioned embodiments are merely used for illustrating the technical solutions of the present disclosure, rather than limiting them; although the present disclosure has been described in detail with reference to the foregoing embodiments, those of ordinary skill in the art should understand that they could still make modifications to the technical solutions recorded in the foregoing embodiments or make equivalent substitutions to a part of or all technical features therein; and these modifications or substitutions do not make the essence of the corresponding technical solutions depart from the scope defined by the claims of the present disclosure.

I/We claim:

1-15. (canceled)

17. A method for realizing a custom menu based on a smart TV, comprising:
receiving resource request information carrying a user ID sent by a client, wherein the resource request information is generated by the client according to a second trigger instruction of a user on an edit button in the custom menu;
obtaining a channel list or an application list from a preset resource library according to the resource request information, and returning the channel list or the application list to the client; or
sending the resource request information to a user center, thus allowing the user center to return a play record corresponding to the current user to the client according to the user ID.

18. The method of claim 17, further comprising:
after obtaining the channel list or the application list from the preset resource library, carrying out match setting on a channel shortcut icon of each channel in the channel list or on an application shortcut icon of each application in the application list according to a preset size of a shortcut icon in the custom menu of the client.

19. The method of claim 18, wherein the carrying out the match setting on the application shortcut icon of each application in the application list comprises:
checking whether a second application shortcut icon corresponding to the application ID of each application in the application list is stored in a first preset database;
using the found second application shortcut icon as the shortcut icon of the application corresponding to the application ID; and
wherein the size of the shortcut icon stored in the first preset database is matched with the preset size of the shortcut icon in the custom menu of the client.

20. An electronic device, comprising:
at least one processor; and
a memory communicably connected with the at least one processor for storing instructions executable by the at least one processor, wherein execution of the instructions by the at least one processor causes the at least one processor to:
receive a custom menu opening instruction;
display the custom menu in a current display interface when receiving the custom menu opening instruction, wherein the custom menu comprises at least one shortcut icon;
receive a first trigger instruction of a user on one shortcut icon in the custom menu; and
display contents corresponding to the shortcut icon, when receiving the first trigger instruction of the user on one shortcut icon in the custom menu.

21. The device of claim 20, the processor is further configured to perform the following steps:
after obtaining the channel list or the application list from the preset resource library, carrying out match setting on a channel shortcut icon of each channel in the channel list or on an application shortcut icon of each application in the application list according to a preset size of a shortcut icon in the custom menu of the client.

22. The device of claim 21, wherein the carrying out the match setting on the application shortcut icon of each application in the application list comprises:
checking whether a second application shortcut icon corresponding to the application ID of each application in the application list is stored in a first preset database;
using the found second application shortcut icon as the shortcut icon of the application corresponding to the application ID; and
wherein the size of the shortcut icon stored in the first preset database is matched with the preset size of the shortcut icon in the custom menu of the client.

23. A non-transitory computer-readable storage medium storing executable instructions that, when executed by an electronic device with a touch-sensitive display, cause the electronic device to:
receive a custom menu opening instruction;
display the custom menu in a current display interface when receiving the custom menu opening instruction, wherein the custom menu comprises at least one shortcut icon;
receive a first trigger instruction of a user on one shortcut icon in the custom menu; and
display contents corresponding to the shortcut icon, when receiving the first trigger instruction of the user on one shortcut icon in the custom menu.

24. The non-transitory computer-readable storage medium of claim 23, the electronic device is further configured to perform the following steps:
after obtaining the channel list or the application list from the preset resource library, carrying out match setting on a channel shortcut icon of each channel in the channel list or on an application shortcut icon of each application in the application list according to a preset size of a shortcut icon in the custom menu of the client.

25. The non-transitory computer-readable storage medium of claim 24, wherein the carrying out the match setting on the application shortcut icon of each application in the application list comprises:
checking whether a second application shortcut icon corresponding to the application ID of each application in the application list is stored in a first preset database;
using the found second application shortcut icon as the shortcut icon of the application corresponding to the application ID; and
wherein the size of the shortcut icon stored in the first preset database is matched with the preset size of the shortcut icon in the custom menu of the client.
